(19) United States
(12) Patent Application Publication
(10) Pub. No.: US 2020/0096401 A1
(43) Pub. Date: Mar. 26, 2020

(54) MATERIAL FOR PRESSURE MEASUREMENT

(71) Applicant: FUJIFILM Corporation, Tokyo (JP)

(72) Inventor: Shinya KATO, Shizuoka (JP)

(73) Assignee: FUJIFILM Corporation, Tokyo (JP)

(21) Appl. No.: 16/698,960

(22) Filed: Nov. 28, 2019

Related U.S. Application Data
(63) Continuation of application No. PCT/JP2018/018397, filed on May 11, 2018.

(30) Foreign Application Priority Data
May 31, 2017 (JP) 2017-108376

(51) Int. Cl. G01L 1/24

(52) U.S. Cl. CPC G01L 1/247

(57) ABSTRACT

A material for pressure measurement including a first material having a color developer layer containing a microcapsule A encapsulating an electron-donating dye precursor disposed on a first base material and a second material having a developer layer containing a clay substance that is an electron-accepting compound disposed on a second base material, in which an arithmetic average roughness Ra of a surface of the developer layer satisfies 1.1 μm<Ra≤3.0 μm.

### CROSS-REFERENCE TO RELATED APPLICATION

This application is a Continuation of International Application No. PCT/JP2018/018397, filed May 11, 2018, which claims priority to Japanese Patent Application No. 2017-108376 filed May 31, 2017. Each of the above applications is hereby expressly incorporated by reference, in its entirety, into the present application.

### BACKGROUND OF THE INVENTION

### 1. Field of the Invention

The present disclosure relates to a material for pressure measurement.

### 2. Description of the Related Art

Materials for pressure measurement (that is, materials that are used for the measurement of pressure) are used in applications such as an attachment step of a glass substrate; solder printing onto a print substrate; the adjustment of pressure between rollers; and the like in the manufacturing of a liquid crystal panel.

As an example of the materials for pressure measurement, there are, for example, pressure measurement films represented by PRESCALE (trade name; registered trademark) provided by Fujifilm Corporation.

In recent years, materials for pressure measurement for measuring a fine pressure have been being studied. For example, JP4986749B discloses, as a material for pressure measurement capable of favorably developing color in a low pressure (particularly, a pressure of 3 MPa or lower) region and capable of favorably reading concentrations, a material for pressure measurement having a plastic base material, a color developer layer including an electron-donating dye precursor, and a developer layer including an electron-accepting compound and using a color development reaction between the electron-donating dye precursor and the electron-accepting compound, in which the electron-donating dye precursor is encapsulated in a microcapsule including a urethan bond, at least one kind of substituent of the electron-accepting compound is a salicylic acid metal salt having a substituent, and the microcapsule satisfies a relationship of δ/D=1.0×10⁻³ to 2.0×10⁻² [δ: the number-average wall thickness (μm) of the microcapsule, D: the volume-standard median size (μm) of the microcapsule].

In addition, JP4986750B discloses, as a material for pressure measurement from which a concentration that can be noticed or read by a fine pressure (particularly, a pressure of lower than 0.1 MPa (preferably a surface pressure)) can be obtained and which is capable of measuring a pressure distribution with a fine pressure, a material for pressure measurement using a color development reaction between an electron-donating dye precursor encapsulated in a microcapsule and an electron-accepting compound, in which, in a case where a volume-standard median size of the microcapsule is A μm, the number of microcapsules having a diameter of (A+5) m or more present per 2 cm×2 cm is 7,000 to 28,000, and a color optical density difference ΔD before and after pressurization at 0.05 MPa is 0.02 or more.

In addition, JP5142640B discloses, as a material for pressure measurement for a low pressure in which color development by friction is suppressed, a material for pressure measurement using a color development reaction between an electron-donating dye precursor and an electron-accepting compound, in which a first material having a color developer layer containing a microcapsule encapsulating the electron-donating dye precursor provided on a base material and a second material having a developer layer containing the electron-accepting compound provided on a base material are included, a ratio (δ/D) of a number-average wall thickness δ of the microcapsule to a volume-standard median size D of the microcapsule is 1.0×10⁻³ or more and 2.0×10⁻² or less, and an arithmetic average roughness Ra of a surface of the developer layer is 0.1 μm or more and 1.1 μm or less.

### SUMMARY OF THE INVENTION

As shown in JP4986749B, JP4986750B, and JP5142640B described above, the materials for pressure measurement for measuring fine pressures are being studied.

However, in recent years, in a background in which an attempt is underway to attain the functional improvement and higher definition of products, there has been an intensifying need for more precisely identifying a region to which a fine pressure is applied.

For example, in the field of liquid crystal panels, there is a case where a vacuum attachment method is employed as an attachment method in order to cope with an increase in size, and, in this case, it is necessary to precisely identify a region to which a pressure of lower than 0.1 MPa (that is, atmospheric pressure) is applied.

In addition, in the field of smartphones, in response to the thickness reduction of modules, attachment at a fine pressure of 0.05 MPa or lower is required from the viewpoint of improving the yield during attachment. Therefore, in the field of smartphones, it is necessary to precisely identify a region to which a fine pressure of 0.05 MPa or lower is applied.

Under the above-described circumstances, the range of measurable pressures of commercially available pressure measurement films, that is, the ranges of pressures in which color development can be obtained by pressurization is a range of 0.05 MPa or higher. Therefore, in a case where a fine pressure of 0.05 MPa or lower is applied to a commercially available pressure measurement film, there is a case where the color optical density difference ΔD before and after pressurization is too small and the pressure cannot be accurately identified.

In the materials for pressure measurement described in JP4986749B, JP4986750B, and JP5142640B as well, the same problem as that of the commercially available pressure measurement films can be caused.

In addition, recently, there has been a case where, in order to more precisely identify a region to which a pressure (particularly, a fine pressure of 0.05 MPa or lower) is applied, it is demanded to coincide a region to which a pressure is actually added and a color development region as much as possible in a material for pressure measurement. In order for that, in the material for pressure measurement, it is necessary to suppress the bleeding of a color development region and improve the visibility of the shape of the color development region.

Here, the expression “improving the visibility of the shape of the color development region” means that the shape of the color development region is approximated to (ideally, coincided to) the shape of the region to which a pressure is actually applied. The visibility of the shape of the color development region refers to a so-called similarity between the shape of the region to which a pressure is actually applied and the shape of the color development region.

With regard to these points, in the case of using the materials for pressure measurement described in JP4986749B, JP4986750B, and JP5142640B or the commercially available pressure measurement films, there is a case where the bleeding of the color development region occurs and/or a case where the visibility of the shape of the color development region becomes poor.

Therefore, an object of an embodiment of the present invention is to provide a material for pressure measurement which has an improved color optical density difference ΔD before and after pressurization at a fine pressure of 0.05 MPa or lower, suppresses the bleeding of a color development region, and is excellent in terms of the visibility of the shape of the color development region.

Specific means for achieving the above-described object includes the following aspects.

<1> A material for pressure measurement comprising:

a first material having a color developer layer containing a microcapsule A encapsulating an electron-donating dye precursor disposed on a first base material; and

a second material having a developer layer containing a clay substance that is an electron-accepting compound disposed on a second base material,

in which an arithmetic average roughness Ra of a surface of the developer layer satisfies 1.1 μm≤Ra≤3.0 μm.

<2> The material for pressure measurement according to <1>, in which an arithmetic average roughness Ra of a surface of the color developer layer satisfies 1.1 μm<Ra≤3.0 μm.

<3> The material for pressure measurement according to <1> or <2>, in which a coefficient of variation of a number-based particle size distribution of particles having a particle diameter of 2 μmin or larger contained in the color developer layer is 50% to 100%.

<4> The material for pressure measurement according to any one of <1> to <3>, in which at least one of the color developer layer or the developer layer contains a microcapsule B not encapsulating the electron-donating dye precursor.

<5> The material for pressure measurement according to any one of <1> to <4>, in which the color developer layer contains a microcapsule B not encapsulating the electron-donating dye precursor.

<6> The material for pressure measurement according to <4> or <5>, in which a material of a capsule wall of the microcapsule B is a melamine formaldehyde resin.

<7> The material for pressure measurement according to any one of <1> to <6>, in which a material of a capsule wall of the microcapsule A is a melamine formaldehyde resin.

<8> The material for pressure measurement according to any one of <1> to <7>, in which the clay substance is at least one selected from the group consisting of acid clay, activated clay, attapulgite, zeolite, bentonite and kaolin.

<9> The material for pressure measurement according to any one of <1> to <8>, in which a color optical density difference ΔD before and after pressurization at 0.03 MPa is 0.15 or more.

<10> The material for pressure measurement according to any one of <1> to <9>, in which the arithmetic average roughness Ra of the surface of the developer layer satisfies 1.1 μm<Ra≤1.6 μm.

<11> The material for pressure measurement according to any one of <1> to <10>, in which the arithmetic average roughness Ra of the surface of the color developer layer satisfies 1.5 μm<Ra≤2.8 μm.

According to an embodiment of the present invention, a material for pressure measurement which has an improved color optical density difference ΔD before and after pressurization at a fine pressure of 0.05 MPa or lower, suppresses the bleeding of a color development region, and is excellent in terms of the visibility of the shape of the color development region is provided.

### DESCRIPTION OF THE PREFERRED EMBODIMENTS

In the present specification, numerical ranges expressed using “to” include numerical values described before and after “to” as the lower limit value and the upper limit value.

Regarding numerical ranges expressed stepwise in the present specification, an upper limit value or a lower limit value described for a certain numerical range may be substituted into the upper limit value or the lower limit value of another numerical range described stepwise. In addition, regarding numerical ranges expressed stepwise in the present specification, an upper limit value or a lower limit value described for a certain numerical range may be substituted into a value described in examples.

In the present specification, in a case where there is a plurality of substances corresponding to a certain component in a composition, unless particularly otherwise described, the amount of the component in the composition refers to the total amount of the plurality of substances present in the composition.

A material for pressure measurement of an embodiment of the present disclosure includes a first material having a color developer layer containing a microcapsule A encapsulating an electron-donating dye precursor disposed on a first base material and a second material having a developer layer containing a clay substance that is an electron-accepting compound disposed on a second base material, and an arithmetic average roughness Ra of a surface of the developer layer satisfies 1.1 μm<Ra≤3.0 μm.

Hereinafter, the arithmetic average roughness Ra will be simply referred as “Ra” in some cases.

The material for pressure measurement of the embodiment of the present disclosure has an improved color optical density difference ΔD before and after pressurization at a fine pressure of 0.05 MPa or lower, suppresses the bleeding of a color development region, and is excellent in terms of the visibility of the shape of the color development region.

In detail, in the material for pressure measurement of the embodiment of the present disclosure, Ra of the surface of the developer layer is more than 1.1 μm, and thus the color optical density difference ΔD increases. The reason therefor is considered to be because the presence of roughness having a certain size on the surface of the developer layer facilitates the concentration of pressure in protrusion portions of the roughness (that is, an effective pressure on the protrusion portions increases) and, consequently, the sensitivity to a fine pressure improves.

In addition, in the material for pressure measurement of the embodiment of the present disclosure, Ra of the surface of the developer layer is 3.0 μm or less, and thus the visibility of the shape of the color development region (in other words, similarity between the shape of a region to which a pressure is actually applied and the shape of the color development region) improves.

The reason therefor is considered to be because the suppression of roughness on the surface of the developer layer to a certain extent alleviates the variation in the density of color development in a region to which a pressure is applied. In contrast, it is considered that, in a case where roughness on the surface of the developer layer is too large and the variation in the density of color development in the region to which a pressure is applied is significant, the visibility of the shape of the color development region is impaired.

In addition, in the material for pressure measurement of the embodiment of the present disclosure, the developer layer contains a clay substance that is an electron-accepting compound, and thus the bleeding of the color development region is suppressed.

The reason therefor is considered to be because the oil absorption property of the developer layer improves. That is, it is considered that, in a case where the microcapsule A breaks due to the application of a pressure (that is, a case where the color development region is formed), a solvent or the like generated from the microcapsule A is absorbed by the clay substance in the developer layer, and consequently, the bleeding of the color development region is suppressed.

[Arithmetic Average Roughness Ra]

The arithmetic average roughness Ra of the surface of the developer layer satisfies 1.1 μm<Ra≤3.0 μm.

The arithmetic average roughness Ra in the present specification refers to the arithmetic average roughness Ra regulated by JIS B0681-6:2014.

From the viewpoint of further improving the visibility of the shape of the color development region, Ra of the surface of the developer layer is preferably 2.8 μm or less (that is, 1.1 μm<Ra≤2.8 μm), more preferably 2.5 μm or less (that is, 1.1 μm<Ra≤2.5 μm), still more preferably less than 1.6 μm (that is, 1.1 μm≤Ra<1.6 μm), and still more preferably 1.5 μm or less (that is, 1.1 μm<Ra≤1.5 μm).

From the viewpoint of further improving the color optical density difference ΔD, Ra of the surface of the developer layer is preferably 1.2 μm or more and more preferably 1.4 μm or more.

Ra of the surface of the developer layer can be adjusted by, for example, changing a dispersion condition under which the clay substance is dispersed.

Ra of the surface of the color developer layer is not particularly limited.

From the viewpoint of more effectively exhibiting the effect of the material for pressure measurement of the embodiment of the present disclosure, Ra of the surface of the color developer layer preferably satisfies 1.1 μm<Ra≤3.0 μm and more preferably satisfies 1.5 μm≤Ra≤2.8 μm.

The material for pressure measurement of the embodiment of the present disclosure includes the first material including the color developer layer and the second material including the developer layer. The material for pressure measurement of the embodiment of the present disclosure is a so-called two-sheet type material for pressure measurement.

Pressure measurement using the material for pressure measurement of the embodiment of the present disclosure is carried out by superimposing the first material and the second material so that a surface of the color developer layer in the first material and a surface of the developer layer in the second material come into contact with each other.

In detail, the first material and the second material in a superimposed state are disposed in a portion in which a pressure or a pressure distribution is measured, and a pressure is applied to the first material and the second material in this state. The pressure may be any of a point pressure, a linear pressure, or a planar pressure.

The application of a pressure breaks the microcapsule A, whereby the electron-donating dye precursor and the clay substance as an electron-accepting compound come into contact with each other and the color development region is formed.

As described above, the material for pressure measurement of the embodiment of the present disclosure is excellent in terms of the color optical density difference ΔD before and after pressurization at a fine pressure of 0.05 MPa or less.

In the material for pressure measurement of the embodiment of the present disclosure, the color optical density difference ΔD before and after pressurization at 0.03 MPa is preferably 0.15 or more, more preferably 0.16 or more, and still more preferably 0.18 or more.

The upper limit of the color optical density difference ΔD before and after pressurization at 0.03 MPa is not particularly limited; however, as the upper limit, for example, 0.25 can be exemplified.

The color optical density difference ΔD is a value obtained by subtracting the color optical density before pressurization at 0.03 MPa from the color optical density after pressurization.

These color optical densities are values measured using a reflection densitometer (for example, RD-19I manufactured by GretagMacbeth LLC).

Hereinafter, the first material and the second material will be described.

[First Material]

The material for pressure measurement of the embodiment of the present disclosure includes the first material having the color developer layer containing the microcapsule A encapsulating the electron-donating dye precursor disposed on the first base material.

The first material includes the first base material and the color developer layer disposed on the first base material.

<First Base Material>

The shape of the first base material in the first material may be any of a sheet shape, a film shape, or a plate shape.

As specific examples of the first base material, paper, a plastic film, synthetic paper, and the like are exemplified.

As specific examples of the paper, wood-free paper, medium-grade paper, groundwood-grade paper, neutral paper, acid paper, recycled paper, coated paper, machine coated paper, art paper, cast coated paper, finely coated paper, tracing paper, and the like can be exemplified.

As specific examples of the plastic film, a polyester film such as a polyethylene terephthalate film, a cellulose derivative film such as cellulose triacetate, a polyolefin film such as polypropylene or polyethylene, a polystyrene film, and the like can be exemplified.

As specific examples of the synthetic paper, paper having a number of microvoids formed by biaxially stretching polypropylene, polyethylene terephthalate, or the like (YUPO and the like), paper produced using a synthetic fiber such as polyethylene, polypropylene, polyethylene terephthalate, or polyamide, paper obtained by laminating the above-described paper on a part, a single surface, or both surfaces, and the like are exemplified.

Among these, from the viewpoint of further increasing the color optical density generated by pressurization, the plastic film and the synthetic paper are preferred, and the plastic film is more preferred.

As the first base material, an easily adhesive layer-attached plastic film may also be used.

As the easily adhesive layer, layers including a urethane resin and/or a blocked isocyanate are included.

<Color Developer Layer>

The color developer layer in the first material contains the microcapsule A encapsulating an electron-donating dye precursor.

The color developer layer may only one kind microcapsule A or may contain two or more kinds of microcapsules A.

For example, the color developer layer may contain two or more kinds of microcapsules A having different volume-based median sizes.

In the color developer layer, the coefficient of variation of the number-based particle size distribution of particles having a particle diameter of 2 μm or more contained in the color developer layer (hereinafter, also referred to as “the CV value of the particle size distribution of the color developer layer” or simply as “the CV value of the particle size distribution”) is preferably 50% to 100%.

In a case where the CV value of the particle size distribution of the color developer layer is 50% or more, the gradation property of color development is excellent.

Here, “the gradation property of color development” refers to a property of the color optical density increasing with an increase in a pressure being applied thereto. A particularly preferred gradation property of color development is a property of the color optical density linearly increasing with an increase in pressure in a pressure range of 0.06 MPa or less (that is, the pressure and the color optical density are proportional to each other).

From the viewpoint of further improving the gradation property of color development, the CV value of the particle size distribution of the color developer layer is more preferably 55% or more and still more preferably 60% or more.

In a case where the CV value of the particle size distribution of the color developer layer is 100% or less, color development by rubbing is suppressed, and the gradation property of color development improves.

Here, “color development by rubbing” refers to color development caused by the rubbing of the color developer layer in the first material and the developer layer in the second material at the time of not measuring pressures. In summary, color development by rubbing is undesirable color development from the viewpoint of pressure measurement (that is, unintended color development). In a case where the CV value of the particle size distribution of the color developer layer is 100% or less, color development by such rubbing is suppressed.

From the viewpoint of further suppressing color development by rubbing and further improving the gradation property of color development, the CV value of the particle size distribution of the color developer layer is more preferably 95% or less and still more preferably 80% or less.

In the present specification, the CV value of the particle size distribution of the color developer layer (that is, the coefficient of variation of the number-based particle size distribution of particles having a particle diameter of 2 μm or more contained in the color developer layer) refers to a value measured as described below.

The surface of the color developer layer in the first material is captured using an optical microscope at 100 times, and the particle diameters of 400 particles having a particle diameter of 2 μm or more included in a range of 0.15 cm² are measured respectively. Here, the particle diameter is regarded as the equivalent circle diameter. In a case where the number of particles having a particle diameter of 2 μm or more in a range of 0.15 cm² does not reach 400, particles having a particle diameter of 2 μm or more present near the range of 0.15 cm² are also regarded as measurement subjects.

Next, the number-based particle size distribution for which the measurement values of 400 particles having a particle diameter of 2 μm or more are used as the population is obtained, and the standard deviation and the number-average particle diameter are respectively calculated on the basis of the obtained particle size distribution.

The CV value of the particle size distribution of the color developer layer is obtained from the following equation on the basis of the obtained standard deviation and number-average particle diameter.

CV value of particle size distribution of color developer layer (%)=(standard deviation/number-average particle diameter)×100

As the particle having a particle diameter of 2 μm or more, specifically, the microcapsule A is exemplified.

In a case where a microcapsule B described below is contained in the color developer layer, as the particle having a particle diameter of 2 μm or more, specifically, the microcapsule B is also exemplified.

The CV value of the particle size distribution of the color developer layer can be adjusted by, for example, jointly using two or more kinds of microcapsules having different volume-based median sizes and adjusting the mixing ratio of the two or more kinds of microcapsules and/or the volume-based median sizes of the respective microcapsules.

As the two or more kinds of microcapsules having different volume-based median sizes, for example, two or more kinds of microcapsules A having different volume-based median sizes, the microcapsule A and the microcapsule B having different volume-based median sizes, and the like are exemplified.

(Microcapsule A)

The microcapsule A encapsulates, as a color developer, an electron-donating dye precursor.

Electron-Donating Dye Precursor

As the electron-donating dye precursor, any substance having a property of developing color by donating an electron or accepting a proton (hydrogen ion: H⁺) of an acid can be used without any particular limitation, and the electron-donating dye precursor is preferably colorless.

Particularly, as the electron-donating dye precursor, a colorless compound having a partial skeleton such as a lactone, a lactam, a sultone, a spiropyran, an ester, an amide, or the like which ring-opens or cleaves in the case of coming into contact with an electron-accepting compound described below.

As the electron-donating dye precursor, specifically, a triphenylmethanephthalide-based compound, a fluoran-based compound, a phenothiazine-based compound, an indolylphthalide-based compound, a leucoauramine-based compound, a rhodamine lactam compound, a triphenylmethane-based compound, a diphenylmethane-based compound, a triazene-based compound, a spiropyran-based compound, a fluorine-based compound, and the like are exemplified.

Regarding the detail of the above-described compounds, the description of JP1993-257272A (JP-H5-257272A) can be referred to.

One kind of electron-donating dye precursor may be used singly or two or more kinds of electro-donating dye precursors may also be used in a mixture form.

As the electron-donating dye precursor, from the viewpoint of enhancing color developability in a fine pressure range of 0.05 MPa or less and developing a density change (density gradient) in a broad pressure range, an electron-donating dye precursor having a high molar light absorption coefficient (ε) is preferred. The molar light absorption coefficient (ε) of the electron-donating dye precursor is preferably 10,000 mol⁻¹·cm⁻¹·L or more, more preferably 15,000 mol⁻¹·cm⁻¹·L or more, and still more preferably 25,000 mol⁻¹·cm⁻¹·L or more.

As preferred examples of the electron-donating dye precursor having ε in the above-described range, 3-(4-diethylamino-2-ethoxyphenyl)-3-(1-ethyl-2-methylindol-3-yl)-4-azaphthalide (ε=61,000), 3-(4-diethylamino-2-ethoxyphenyl)-3-(1-n-octyl-2-methylindol-3-yl) phthalide (ε=40,000), 3-[2,2-bis(1-ethyl-2-methylindol-3-yl) vinyl]-3-(4-diethylaminophenyl)-phthalide (ε=40,000), 9-[ethyl(3-methylbutyl)amino] spiro [12H-benzo[a]xanthene-12,1′(3′H)isobenzofuran]-3′-one (ε=34,000), 2-anilino-6-dibutylamino-3-methylfluorane (ε=22,000), 6-diethylamino-3-methyl-2-(2,6-xylidino)-fluorane (ε=19,000), 2-(2-chloroanilino)-6-dibutylaminofluoran (ε=21,000), 3,3-bis(4-dimethylaminophenyl)-6-dimethylaminophthalide (ε=16,000), 2-anilino-6-diethylamino-3-methylfluoran (ε=16,000), and the like are exemplified.

In a case where one kind of electron-donating dye precursor having a molar light absorption coefficient e in the above-described range is singly used or two or more kinds of electron-donating dye precursors having a molar light absorption coefficient ε in the above-described range are used in a mixture form, the proportion of the electron-donating dye precursor having a molar light absorption coefficient (ε) of 10,000 mol⁻¹·cm⁻¹·L or more in the total amount of the electron-donating dye precursor is preferably in a range of 10% by mass to 100% by mass, more preferably in a range of 20% by mass to 100% by mass, and still more preferably in a range of 30% by mass to 100% by mass from the viewpoint of enhancing color developability in a fine pressure range of 0.05 MPa or less and developing a density change (density gradient) in a broad pressure range.

In the case of using two or more kinds of electron-donating dye precursors, it is preferable to jointly use two or more kinds of electron-donating dye precursors each having ε of 10,000 mol⁻¹·cm⁻¹·L or more.

The molar light absorption coefficient (ε) can be computed from the light absorbance at the time of dissolving an electron-donating colorless dye in a 95% acetic acid aqueous solution. Specifically, in a case where, in a 95% acetic acid aqueous solution of an electron-donating colorless dye having a concentration adjusted so that the light absorbance reaches 1.0 or less, the length of a cell for measurement is represented by A cm, the concentration of the electron-donating colorless dye is represented by B mol/L, and the light absorbance is represented by C, the molar light absorption coefficient can be computed from the following equation.

Molar light absorption coefficient (ε)=C/(A×B)

The content (for example, amount applied) of the electron-donating dye precursor in the color developer layer is preferably 0.1 g/m² to 5 g/m², more preferably 0.1 g/m² to 4 g/m², and still more preferably 0.2 g/m² to 3 g/m² in terms of the mass after drying from the viewpoint of enhancing color developability in a fine pressure range of 0.05 MPa or less.

Solvent

The microcapsule A preferably encapsulates at least one solvent.

As the solvent, it is possible to use solvents that are well known in the applications of pressure sensitive copying paper or thermosensitive recording paper.

As the solvent, specifically, for example, aromatic hydrocarbons such as alkylnaphthalene-based compounds such as diisopropyl naphthalene, diarylalkane-based compounds such as 1-phenyl-1-xylylethane, alkylbiphenyl-based compounds such as isopropylbiphenyl, triarylmethane-based compounds, alkylbenzene-based compounds, benzylnaphthalene-based compounds, diarylalkylene-based compounds, and arylindane-based compounds; aliphatic hydrocarbons such as dibutyl phthalate and isoparaffins; natural animal and vegetable oils such as soybean oil, corn oil, cottonseed oil, rapeseed oil, olive oil, coconut oil, castor oil, and fish oil; natural product high-boiling fractions such as paraffinum liquidum; and the like are exemplified.

One kind of solvent may be used singly or two or more kinds of solvents may be used in a mixture form.

From the viewpoint of color developability, the mass ratio (solvent:precursor) between the solvent and the electron-donating dye precursor that are encapsulated in the microcapsule A is preferably in a range of 98:2 to 30:70, more preferably in a range of 97:3 to 40:60, and still more preferably in a range of 95:5 to 50:50.

Auxiliary Solvent

The microcapsule A may also encapsulate an auxiliary solvent as necessary.

As the auxiliary solvent, solvents having a boiling point of 130° C. or lower are exemplified.

As the auxiliary solvent, more specifically, for example, ketone-based compounds such as methyl ethyl ketone, ester-based compounds such as ethyl acetate, alcohol-based compounds such as isopropyl alcohol, and the like are exemplified.

Other Components

The microcapsule A may also contain components other than the above-described components as necessary.

As the other components, additives such as an ultraviolet absorber, a light stabilizer, an antioxidant, wax, and an odor suppressor can be exemplified.

Volume-Based Median Size (D50A) of Microcapsule A

The volume-based median diameter (hereinafter, also referred to as “D50A”) of the microcapsule A is not particularly limited, but is preferably more than 10 μm and less than 40 μm.

In a case where D50A is less than 40 μm, the color developability does not become too high, and thus color development by rubbing can be further suppressed.

In a case where D50A is more than 10 μm, it is possible to further suppress unevenness on the surface of the color developer layer (for example, application unevenness in an aspect in which the color developer layer is formed by application).

D50A is preferably 20 μm to 35 μm and more preferably 25 μm to 35 μm.

Number-Average Wall Thickness of Microcapsule A

The number-average wall thickness of the microcapsule A depends on a variety of conditions such as the material of the capsule wall and D50A and is preferably 10 nm to 150 nm, more preferably 20 μm to 100 nm, and still more preferably 20 nm to 90 nm from the viewpoint of color developability in a fine pressure range of 0.05 MPa or lower.

In the present specification, a wall thickness of the microcapsule refers to the thickness (μm) of a capsule wall (for example, a resin film that forms the microcapsule) of the microcapsule. The concept of the microcapsule mentioned herein includes both the microcapsule A and the microcapsule B.

The number-average wall thickness of the microcapsule refers to a number average value obtained by obtaining the thicknesses (μm) of the respective capsule walls of five microcapsules using a scanning electron microscope (SEM) and number-averaging (that is, simply averaging) the obtained measurement values (five measurement values) of the thicknesses of the capsule walls.

Specifically, first, a microcapsule-containing liquid is applied onto a random base material (for example the first base material) and dried, thereby forming an applied film. A cross-sectional slice of the obtained applied film is produced, and the cross section thereof is observed using SEM. From the obtained SEM image, five random microcapsules are selected. The cross sections of the selected five microcapsules are observed, and the thicknesses of the capsule walls of the five microcapsules are obtained respectively. The measurement values (five measurement values) of the thicknesses of the capsule walls are number-averaged, and the obtained number-average value is regarded as the number-average wall thickness of the microcapsule.

The ratio of the number-average wall thickness of the microcapsule A to D50A of the microcapsule A (that is, the number-average wall thickness/D50A ratio) is preferably 1.0×10⁻³ to 4.0×10⁻³ and more preferably 1.3×10⁻³ to 2.5×10⁻³ from the viewpoint of color developability in a fine pressure range of 0.05 MPa or less.

Wall Material of Microcapsule A

As a wall material of the microcapsule A (that is, a material of the capsule wall), a resin is preferred.

As the wall material of the microcapsule A, for example, resins known as a wall material of electron-donating dye precursor-containing microcapsules in pressure sensitive recording materials or thermosensitive recording materials (for example, a urethane-urea resin, a melamine formaldehyde resin, gelatin, and the like) are exemplified.

As the wall material of the microcapsule A, from the viewpoint of obtaining favorable color development at a low pressure (preferably lower than 0.1 MPa), a urethane-urea resin or a melamine formaldehyde resin is preferred.

As the wall material of the microcapsule A, from the viewpoint of maintaining the ratio of the color optical density in the case of using the first material after storage to the color optical density in the case of using the first material before storage on a higher level, a melamine formaldehyde resin is preferred.

From the viewpoint of obtaining favorable color development at a low pressure (preferably lower than 0.1 MPa), the content of the microcapsule A in the color developer layer is preferably 50% by mass or more and more preferably 60% by mass or more of the total solid content amount of the color developer layer.

The upper limit of the content of the microcapsule A with respect to the total solid content amount of the color developer layer is not particularly limited, and, as the upper limit, for example, 80% by mass or less can be exemplified.

(Microcapsule B)

From the viewpoint of suppressing color development by rubbing, at least one of the color developer layer in the first material or the developer layer in the second material preferably contains a microcapsule B not encapsulating the electron-donating dye precursor.

In a case where at least one of the color developer layer in the first material or the developer layer in the second material contains the microcapsule B not encapsulating the electron-donating dye precursor, the breakage of the microcapsule B at the time of the rubbing between the color developer layer in the first material and the developer layer in the second material suppresses the breakage of the microcapsule A. Therefore, color development by rubbing is suppressed. That is, the microcapsule B has a function of suppressing the breakage of the microcapsule A by being broken (that is, a function as a dummy capsule).

In a case where at least one of the color developer layer in the first material or the developer layer in the second material contains the microcapsule B, only one kind of microcapsule B may be contained or two or more kinds of microcapsules (for example, two or more kinds of microcapsules having different volume-based median sizes) may be contained.

The microcapsule B can be contained at least one of the color developer layer in the first material or the developer layer in the second material; however, from the viewpoint of more effectively exhibiting an effect for suppressing color development by rubbing, the microcapsule is preferably contained in the color developer layer in the first material.

Components Encapsulated in Microcapsule B

The microcapsule B preferably encapsulates a solvent.

A preferred solvent that can be encapsulated in the microcapsule B is the same as the preferred solvent that can be encapsulated in the microcapsule A.

Additionally, as components that can be encapsulated in the microcapsule B, the components that can be encapsulated in the microcapsule A except for the electron-donating dye precursor are exemplified.

Volume-Based Median Size (D50B) of Microcapsule B

The volume-based median diameter (hereinafter, also referred to as “D50B”) of the microcapsule B is preferably larger than D50A of the microcapsule A from the viewpoint of further suppressing color development by rubbing. In such a case, an effect of the microcapsule B for suppressing color development by rubbing is more effectively exhibited.

D50B of the microcapsule B is preferably more than 40 μm and less than 150 μm.

In a case where D50B of the microcapsule B is more than 40 μm, the effect for suppressing color development by rubbing is more effectively exhibited.

In a case where D50B of the microcapsule B is less than 150 μm, it is possible to further suppress unevenness on the color developer layer and/or the developer layer in which the microcapsule B is contained (for example, application unevenness in the aspect in which the color developer layer is formed by application). In addition, in a case where the microcapsule B is contained in the color developer layer and D50B is less than 150 μm, the CV value of the particle size distribution in the color developer layer does not become too large, and thus the gradation property of color development further improves.

A preferred aspect of the case where at least one of the color developer layer in the first material or the developer layer in the second material contains the microcapsule B is an aspect in which D50A of the microcapsule A is more than 10 μm and less than 40 μm and D50B of the microcapsule B is more than 40 μm and less than 150 μm. A more preferred range of each of D50A and D50B in this aspect is as described above.

Number-Average Wall Thickness of Microcapsule B

The number-average wall thickness of the microcapsule B depends on a variety of conditions such as the material of the capsule wall and D50B and is preferably 50 nm to 1,000 nm, more preferably 70 nm to 500 nm, still more preferably 100 nm to 300 nm, and still more preferably 100 nm to 200 nm from the viewpoint of more effectively exhibiting the function of the microcapsule B.

The ratio of the number-average wall thickness of the microcapsule B to D50B of the microcapsule B (that is, the number-average wall thickness/D50B ratio) is preferably 1.0×10⁻³ to 4.0×10⁻³ and more preferably 1.3×10⁻³ to 2.5×10⁻³ from the viewpoint of more effectively exhibiting the function of the microcapsule B.

Wall Material of Microcapsule B

A preferred aspect of a wall material of the microcapsule B is the same as the preferred aspect of the wall material of the microcapsule A.

In a case where the color developer layer contains the microcapsule B, from the viewpoint of more effectively exhibiting the function of the microcapsule B, the content of the microcapsule B with respect to the content of the microcapsule A in the color developer layer is preferably 1% by mass to 50% by mass and more preferably 5% by mass to 50% by mass, and still more preferably 10% by mass to 30% by mass.

(Other Components)

The color developer layer may contain components other than the microcapsule A and the microcapsule B.

As the other components, a water-soluble polymeric binder (for example, fine powder of starch or a starch derivative, a buffer such as cellulose fiber powder, polyvinyl alcohol, or the like), a hydrophobic polymeric binder (for example, a vinyl acetate-based binder, an acrylic binder, a styrene-butadiene copolymer latex, or the like), a surfactant, inorganic particles (for example, silica particles), a fluorescent brightener, an antifoaming agent, a penetrating agent, an ultraviolet absorber, a preservative, and the like are exemplified.

As the surfactant that is used in the color developer layer, for example, an alkylbenzene sulfonate that is an anionic surfactant (for example, NEOGEN T manufactured by DKS Co., Ltd.), polyoxyalkylene lauryl ether that is a nonionic surfactant (for example, NOIGEN LP70 manufactured by DKS Co., Ltd.), and the like are exemplified.

As the silica particles that are used in the color developer layer, for example, gas phase process silica, colloidal silica, and the like are exemplified.

Regarding the silica particles, as examples of a commercially available product in the market, SNOWTEX series manufactured by Nissan Chemical Corporation (for example, SNOWTEX (registered trademark) 30) and the like are exemplified.

(Coating Fluid for Forming Color Developer Layer)

The color developer layer can be formed by, for example, imparting (for example, applying) a coating fluid for forming the color developer layer containing the above-described components of the color developer layer and a liquid component (for example, water) to the first base material and drying the coating fluid.

The coating fluid for forming the color developer layer can be prepared by, for example, preparing a water dispersion liquid of the microcapsule A and, as necessary, mixing the water dispersion liquid of the microcapsule A and other components.

In the case of forming the color developer layer containing two or more kinds of microcapsules A having different D50A's or the like, it is preferable to prepare water dispersion liquids for the two or more kinds of microcapsules A each and prepare coating fluids for forming the color developer layer using the obtained water dispersion liquids of the two or more kinds of microcapsules A.

The coating fluid for forming the color developer layer which is intended to form the color developer layer containing the microcapsule B is preferably prepared by preparing a water dispersion liquid of the microcapsule A and a water dispersion of the microcapsule B respectively and using the obtained water dispersion liquid of the microcapsule A, the obtained water dispersion of the microcapsule B, and other components.

In the case of forming the color developer layer by applying the coating fluid for forming the color developer layer onto the first base material, the coating fluid can be applied using a well-known application method.

As the application method, for example, application methods using an air knife coater, a rod coater, a bar coater, a curtain coater, a gravure coater, an extrusion coater, a die coater, a slide bead coater, a blade coater, or the like are exemplified.

The mass of the color developer layer that is formed on the first base material (the mass after drying in the case of forming the color developer layer by application and drying) is preferably 1 g/m² to 10 g/m², more preferably 1 g/m² to 5 g/m², and particularly preferably 2 g/m² to 4 g/m².

<Undercoat Layer>

The first material may include an undercoat layer between the first base material and the color developer layer.

The undercoat layer preferably includes a binder resin.

As the binder resin, acrylic resins (for example, an acrylic acid ester-based polymer, polyacrylic acid, and the like), styrene-butadiene copolymers, vinyl acetate-based polymers, polyvinyl alcohol, maleic anhydride-styrene copolymers, synthetic or natural polymeric substances such as starch, casein, arabic gum, gelatin, carboxymethylcellulose, and methylcellulose are exemplified.

The undercoat layer may also contain components (a surfactant and the like) other than the binder resin.

The film thickness of the undercoat layer is preferably 0.5 μm to 20 μm, more preferably 1 μm to 10 μm, and still more preferably 2 μm to 6 μm.

The undercoat layer can be formed by, for example, imparting (for example, applying) a coating fluid for forming the undercoat layer containing the above-described components of the undercoat layer and a liquid component (for example, water) to the first base material and drying the coating fluid.

The coating fluid for forming the color developer layer can be prepared by, for example, mixing a water dispersion liquid of a resin and other components.

As an application method in the case of forming the undercoat layer by applying the coating fluid for forming the undercoat layer onto the first base material, the same method as the application method of the coating fluid for forming the color developer layer is exemplified.

In the case of manufacturing the first material including the undercoat layer between the first base material and the color developer layer, it is needless to say that the color developer layer is formed on the undercoat layer formed on the first base material.

[Second Material]

The material for pressure measurement of the embodiment of the present disclosure includes the second material having the developer layer containing the clay substance that is an electron-accepting compound disposed on the second base material.

The second material includes the second base material and the developer layer disposed on the second base material.

<Second Base Material>

As the second base material, the same base material as the first base material is exemplified.

In the material for pressure measurement of the embodiment of the present disclosure, the material of the first base material and the material of the second base material may be identical to or different from each other.

<Developer Layer>

The developer layer contains the clay substance that is an electron-accepting compound (hereinafter, also referred to as “clay substance”).

As described above, the clay substance contained in the developer layer suppresses the bleeding of the color development region.

(Clay Substance)

From the viewpoint of further suppressing the bleeding of the color development region, the clay substance is preferably at least one selected from the group consisting of acid clay, activated clay, attapulgite, zeolite, bentonite, or kaolin.

From the viewpoint of further suppressing the bleeding of the color development region, the clay substance preferably includes at least one selected from the group consisting of acid clay, activated clay, or kaolin.

As the activated clay, sulfate-treated clay obtained by treating acid clay or bentonite with sulfuric acid is preferred.

From the viewpoint of further suppressing the bleeding of the color development region, the content of the clay substance in the developer layer is preferably 50% by mass or more, more preferably 60% by mass or more, and still more preferably 70% by mass or more of the total solid content amount of the developer layer. The content of the clay substance in the developer layer may be 100% by mass of the total solid content amount of the developer layer.

(Electron-Accepting Compound Other than Clay Substance)

The developer layer may also contain an electron-accepting compound other than the clay substance.

As the electron-accepting compound other than the clay substance, organic compounds such as metal salts of aromatic carboxylic acids, phenol formaldehyde resins, and metal salts of carboxylated terpene phenol resins are exemplified.

As preferred specific examples of the metal salts of aromatic carboxylic acids, zinc salts, nickel salts, aluminum salts, calcium salts, and the like of salicylic acid resins that are reaction products between 3,5-di-t-butylsalicylic acid, 3,5-di-t-octylsalicylic acid, 3,5-di-t-nonylsalicylic acid, 3,5-di-t-dodecylsalicylic acid, 3-methyl-5-t-dodecylsalicylic acid, 3-t-dodecylsalicylic acid, 5-t-dodecylsalicylic acid, 5-cyclohexylsalicylic acid, 3,5-bis(α,α-dimethylbenzyl) salicylic acid, 3-methyl-5-(α-methylbenzyl) salicylic acid, 3-(α,α-dimethylbenzyl)-5-methylsalicylic acid, 3-(α,α-dimethylbenzyl)-6-methylsalicylic acid, 3-(α-methylbenzyl)-5-(α,α)-dimethylbenzyl) salicylic acid, 3-(α,α-dimethylbenzyl)-6-ethylsalicylic acid, 3-phenyl-5-(α,α-dimethylbenzyl) salicylic acid, carboxy-modified terpene phenolic resin, or 3,5-bis(α-methylbenzyl) salicylic acid and benzyl chloride can be exemplified.

In a case where the developer layer contains or does not contain the electron-accepting compound other than the clay substance, the content of the clay substance with respect to the total amount of the electron-accepting compound in the developer layer is preferably 50% by mass or more, more preferably 60% by mass or more, and still more preferably 70% by mass or more of the total solid content amount of the developer layer.

In the developer layer, in a case where the content of the clay substance with respect to the total amount of the electron-accepting compound in the developer layer is 50% by mass or more, the above-described function (the function of suppressing the bleeding of the color development region) of the clay substance is more effectively exhibited.

The content of the clay substance with respect to the total amount of the electron-accepting compound may be 100% by mass. That is, the developer layer may not contain the electron-accepting compound other than the clay substance.

(Other Components)

The developer layer may contain components other than the electron-accepting compound.

As the other components, a binder resin, a pigment, a fluorescent brightener, an antifoaming agent, a penetrating agent, a preservative, and the like are exemplified.

As the other components, the microcapsule B is also exemplified.

As the binder resin, for example, acrylic resins (for example, an acrylic acid ester-based polymer, polyacrylic acid, and the like), styrene-butadiene copolymers, vinyl acetate-based polymers, polyvinyl alcohol, maleic anhydride-styrene copolymers, synthetic or natural polymeric substances such as starch, casein, arabic gum, gelatin, carboxymethylcellulose, and methylcellulose are exemplified.

As the pigment, for example, heavy calcium carbonate, light calcium carbonate, talc, rutile-type titanium dioxide, anatase-type titanium dioxide, and the like are exemplified.

The mass of the developer layer that is formed on the second base material is preferably 1 g/m² to 20 g/m², more preferably 2 g/m² to 18 g/m², and particularly preferably 3 g/m² to 15 g/m².

The developer layer can be formed by, for example, imparting (for example, applying) a coating fluid for forming the developer layer containing the components (at least the clay substance) of the developer layer and a liquid component (for example, water) to the second base material and drying the coating fluid.

The coating fluid for forming the developer layer is preferably, for example, a water dispersion liquid of the clay substance.

Ra of the surface of the developer layer can be easily adjusted by changing a dispersion condition of the clay substance at the time of preparing a water dispersion liquid of the clay substance.

The easiness in the adjustment of Ra of the surface of the developer layer is also one of advantages of the use of the clay substance that is an electron-accepting compound.

As an application method in the case of forming the developer layer by applying the coating fluid for forming the developer layer onto the second base material, the same method as the application method of the coating fluid for forming the color developer layer is exemplified.

### EXAMPLES

Hereinafter, the present invention will be specifically described using examples, but the present invention is not limited to the following examples within the scope of the gist of the present invention. In the following description, unless particularly otherwise described, “%” and “parts” are mass-based.

In the following description, the densities of color development regions were measured using a reflection densitometer RD-19I (manufactured by GretagMacbeth LLC).

### Example 1

<Preparation of Microcapsule A-Containing Liquid>

The following compound (A) (20 parts) that is an electron-donating dye precursor was dissolved in linear alkyl benzene (JXTG Nippon Oil & Energy Corporation, GRADE ALKENE L) (57 parts), thereby obtaining a solution A.

The obtained solution A was stirred, and synthetic isoparaffin (Idemitsu Kosan Co., Ltd., IP SOLVENT 1620) (15 parts) and N,N,N′,N′-tetrakis(2-hydroxypropyl)ethylene diamine (ADEKA Corporation, ADEKA POLYETHER EDP-300) dissolved in ethyl acetate (1.2 parts) (0.2 parts) were added thereto, thereby obtaining a solution B.

The obtained solution B was stirred, and a trimethylolpropane adduct of torylene diisocyanate (DIC Corporation, BURNOCK D-750) dissolved in ethyl acetate (3 parts) (1.2 parts) was added thereto, thereby obtaining a solution C.

Next, the solution C was added to a solution obtained by dissolving polyvinyl alcohol (PVA-205, Kuraray Co., Ltd.) (9 parts) in water (140 parts), emulsified, and dispersed.

Water (340 parts) was added to the obtained emulsified liquid, heated up to 70° C. under stirring, stirred for one hour, and then cooled. Water was further added to the cooled liquid, thereby adjusting the solid content concentration.

A microcapsule A1-containing liquid containing a microcapsule A1 as the microcapsule A encapsulating an electron-donating dye precursor (solid content concentration: 19.6%) was obtained in the above-described manner.

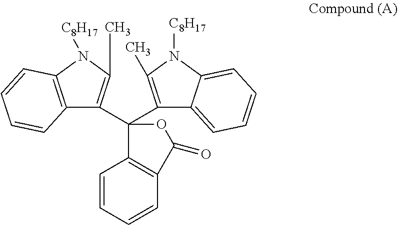

For the microcapsule A1 that was contained in the microcapsule A1-containing liquid, the volume-based median size (hereinafter, also referred to as “D50A”) and the number-average wall thickness (hereinafter, also referred to as “wall thickness”) were values shown in Table 1.

In addition, a material of a capsule wall (hereinafter, also referred to as “wall material”) of the microcapsule A1 was, as shown in Table 1, a urethane-urea resin (hereinafter, also referred as “PUR”).

The D50A and wall thickness of the microcapsule A1 were computed as described below.

First, the microcapsule A1-containing liquid was applied and dried on a 75 μm-thick polyethylene terephthalate (PET) sheet, thereby obtaining an applied film.

D50A of the microcapsule A1 was computed on the basis of a result obtained by capturing a surface of the applied film using an optical microscope at a magnification of 150 times and measuring the equivalent circle diameters of all of the microcapsule A1 present in a 2 cm×2 cm range.

The wall thickness (that is, the number-average wall thickness) of the microcapsule A1 was computed by forming a cross section of the applied film, selecting five microcapsule A1 from the formed cross section, obtaining the thicknesses (μm) of individual capsule walls using a scanning electron microscope (SEM), and simply averaging the obtained values.

<Preparation of Coating Fluid for Forming Color Developer Layer>

The microcapsule A1-containing liquid (18 parts), water (63 parts), colloidal silica (Nissan Chemical Corporation, SNOWTEX 30, content of solid content: 30%) (1.8 parts), a 10% aqueous solution of carboxymethylcellulose sodium (DKS Co., Ltd., CELLOGEN 5A) (1.8 parts), a 1% aqueous solution of carboxymethylcellulose sodium (DKS Co., Ltd., CELLOGEN EP) (30 parts), a 15% aqueous solution of sodium alkylbenzene sulfonate (DKS Co., Ltd., NEOGEN T) (0.3 parts), and a 1% aqueous solution of NOIGEN LP70 (DKS Co., Ltd.) (0.8 parts) were mixed together, thereby obtaining a coating fluid for forming a color developer layer.

<Production of First Material>

The coating fluid for forming a color developer layer was stirred for two hours, then, applied onto a 75 μm-thick polyethylene terephthalate (PET) sheet (first base material) so that the mass after drying reached 2.8 g/m², and dried, thereby forming a color developer layer.

A first material having the color developer layer containing the microcapsule A1 disposed on the first base material was obtained in the above-described manner.

<Preparation of Coating Fluid for Forming Developer Layer>

A 40% sodium hydroxide aqueous solution (5 parts) and water (300 parts) were added to activated clay (100 parts) as a clay substance that is an electron-accepting compound, and the obtained liquid was dispersed using a homogenizer, thereby obtaining a dispersion liquid.

A 10% aqueous solution of a sodium salt of casein (50 parts) and styrene-butadiene latex (30 parts as the solid content amount) were added to the obtained dispersion liquid, thereby obtaining a coating fluid for forming a developer layer containing the clay substance.

As the activated clay, “FURACOLOR SR” that is sulfate-treated activated clay manufactured by BYK Additives & Instruments was used.

<Production of Second Material>

The coating fluid for forming a developer layer was applied onto a 75 μm-thick polyethylene terephthalate (PET) sheet (second base material) so that the amount of the solid content applied reached 12.0 g/m², and dried, thereby forming a developer layer.

A second material having the developer layer containing the clay substance (activated clay) disposed on the second base material was obtained in the above-described manner.

A two-sheet type material for pressure measurement including the first material and the second material was obtained in the above-described manner.

<Measurement and Evaluation>

The following measurement and evaluation were carried out using the obtained material for pressure measurement. The results are shown in Table 1.

(CV Value of Particle Size Distribution)

The coefficient of variation of the number-based particle size distribution of particles having a particle diameter of 2 μm or more contained in the color developer layer in the first material (in the present embodiment, referred to as “the CV value of the particle size distribution”) was measured using the above-described method.

(Arithmetic Average Roughness Ra of Surface of Developer Layer)

The arithmetic average roughness Ra of the surface of the developer layer in the second material was measured using the above-described method.

As a measurement instrument, a scanning-type white interferometer using optical interferometry (in detail, NewView5020: Micro mode manufactured by Zygo Corporation) was used.

(Color Optical Density Difference ΔD Before and after Pressurization at 0.03 MPa)

The first material and the second material were respectively cut to a 5 cm×5 cm size.

The cut first material and the cut second material were superimposed so that a surface of the color developer layer in the first material and a surface of the developer layer in the second material came into contact with each other.

The superimposed first material and second material were placed on a desk in a state of being sandwiched between two glass plates having a flat surface, and then a weight was placed on these two glass plates, thereby pressurizing the first material and the second material sandwiched between the two glass plates at a pressure of 0.03 MPa for 120 seconds.

After pressurization, the first material and the second material were peeled off from each other.

Next, the density after 20 μminutes from the end of the pressurization (hereinafter, regarded as “color optical density DA”) in a color development region formed in the developer layer in the second material was measured.

Separately from the above-described density, the density of the developer layer in an unused second material (hereinafter, regarded as “initial density DB”) was used.

The initial density DB was subtracted from the color optical density DA, and the obtained result was regarded as the color optical density difference ΔD before and after pressurization at 0.03 MPa.

(Bleeding of Color Development Region)

A color development region was formed in the developer layer in the second material by changing the following facts in the measurement of the color optical density DA.

Facts Changed in Measurement of Color Optical Density DA

The weight placed on the two glass plates was changed to an SUS plate having a 3 mm-wide void, and the pressure was changed from 0.03 MPa to 0.04 MPa.

The color development region formed in the developer layer in the second material was visually observed, and the bleeding of the color development region was evaluated according to the following evaluation standards.

In the following evaluation standards, the bleeding of the color development region is further suppressed as the numerical values of evaluation ranks increases. The evaluation rank at which the bleeding of the color development region is most suppressed is “5”.

Evaluation Standards of Bleeding of Color Development Region

5: A color development region having a void corresponding to the above-described void of the SUS plate was formed in the developer layer in the second material, and the bleeding of an edge portion of the color development region did not occur.

4: A color development region having a void corresponding to the above-described void of the SUS plate was formed in the developer layer in the second material, and the bleeding of the edge portion of the color development region was extremely slight.

3: The bleeding of the edge portion of the color development region occurred, but the void in the color development region could be sufficiently recognized.

2: Due to the bleeding of the edge portion of the color development region, a place in which the void in the color development region could not be recognized was generated.

1: The bleeding of the edge portion of the color development region was significant, and the void in the color development region could not be recognized.

(Visibility of Shape of Color Development Region)

A color development region was formed in the developer layer in the second material by changing the following facts in the evaluation of the bleeding of the color development region.

Facts Changed in Evaluation of Bleeding of Color Development Region

The SUS plate having a 3 μmm-wide void placed on the two glass plates was changed to a 2 μmm-wide ring-shaped SUS plate.

The color development region formed in the developer layer in the second material was visually observed, and the visibility of the shape of the color development region was evaluated according to the following evaluation standards.

In the following evaluation standards, the visibility of the shape of the color development region becomes more favorable as the numerical values of evaluation ranks increases. The evaluation rank at which the visibility of the shape of the color development region is most favorable is “5”.

Evaluation Standards of Visibility of Shape of Color Development Region

5: There was no variation in the density of color development, and the fact that the shape of the color development region was the same ring shape as that of the SUS plate could be extremely favorably recognized.

4: The density of color development slightly varied, but the fact that the shape of the color development region was the same ring shape as that of the SUS plate could be extremely favorably recognized.

3: The density of color development varied, but the fact that the shape of the color development region was a ring shape could be sufficiently recognized.

2: Due to the variation in the density of color development, a place in which that fact that the shape of the color development region was a ring shape could not be partially recognized was generated.

1: The density of color development significantly varied, and the fact that the shape of the color development region was a ring shape could not be recognized.

(Color Development by Rubbing)

The first material and the second material were respectively cut to a 10 cm×15 cm size.

The cut first material and the cut second material were superimposed so that a surface of the color developer layer in the first material and a surface of the developer layer in the second material came into contact with each other.

The color developer layer and the developer layer were rubbed against each other by reciprocally moving the first material against the second material 20 times in the above-described state.

The developer layer in the second material after rubbing was visually observed, and color development by rubbing was evaluated according to the following evaluation standards.

In the following evaluation standards, color development by rubbing (that is, unintended color development) is further suppressed as the numerical values of evaluation ranks increases. The evaluation rank at which color development by rubbing is most suppressed is “5”.

Evaluation Standards of Color Development by Rubbing

5: Color development in the developer layer in the second material was not recognized.

4: Color development in the developer layer in the second material was extremely slightly recognized, which was on a level of no practical problem.

3: Color development was observed in some of the developer layer in the second material, which was on a level of no practical problem.

2: Color development was observed in the majority of the developer layer in the second material, which was on a level with a practical problem.

1: Color development was observed on the entire surface of the developer layer in the second material, which was on a level with a practical problem.

(Gradation Property of Color Development)

Color optical densities in the cases of applying individual pressures of 0.02 MPa, 0.03 MPa, 0.04 MPa, 0.05 MPa, and 0.06 MPa by changing the weight of the weight placed on the two glass plates in the above-described measurement of the color optical density DA were measured respectively.

On the basis of the measurement results, the gradation property of color development was evaluated according to the following evaluation standards.

In the following evaluation standards, the gradation property of color development becomes more favorable as the numerical values of evaluation ranks increases. The evaluation rank at which the gradation property of color development is most favorable is “5”.

Evaluation Standards of Gradation Property of Color Development

5: A high color optical density was shown in a condition of 0.06 MPa, and an increase in the color optical density with an increase in the pressure was linear.

4: A high color optical density was shown in a condition of 0.06 MPa, and there were a small number of folding points in the increase in the color optical density with the increase in the pressure, which was on a level of no practical problem.

3: The density at 0.06 Mpa was low or the increase in the color optical density with the increase in the pressure in a pressure range of 0.04 MPa or lower was saturated, which was on a level of no practical problem.

2: The density at 0.06 Mpa was low or the increase in the color optical density with the increase in the pressure in a pressure range of 0.03 MPa or lower was saturated, which was on a level with a practical problem.

1: The density at 0.06 Mpa was near zero or the increase in the color optical density with the increase in the pressure was not shown, which was on a level with a practical problem.

(Color Development Rate)

In the above-described measurement of the color optical density DA, the density of the color development region was measured every 30 seconds from the end of pressurization.

In a case where the above-described color optical density DA (that is, the color optical density 20 μminutes after the end of pressurization) was set to 100%, a time taken to obtain a color optical density of 80% or more (that is, a time taken from the end of pressurization to the measurement of the density) was confirmed.

The color development rate becomes faster as the time taken to obtain the color optical density of 80% or more becomes shorter.

(Color Optical Density after Storage (Relative Value))

The first material was stored for ten days in an environment of 45° C. and 70% RH.

The same operation as that in a condition of 0.06 MPa regarding the above-described gradation property of color development was carried out using the first material after storage, and the density in the color development region of the developer layer (hereinafter, referred to as “color optical density DC”) was measured.

Regarding the color optical density DC, a relative value (%) of a case where the color optical density in a condition of 0.06 MPa regarding the above-described gradation property of color development was set to 100% was computed and regarded as the color optical density after storage (relative value).

### Examples 2 and 3

The same operation as in Example 1 was carried out except for the fact that the D50A and wall thickness of the microcapsule A1 were changed as shown in Table 1. The results are shown in Table 1.

The D50A and wall thickness of the microcapsule A1 were changed by changing the stirring rotation rate per unit time during the emulsification and dispersion in the preparation of the microcapsule A1-containing liquid.

Specifically, as the stirring rotation rate per unit time decreases, D50A of the microcapsule A1 increases, and the wall thickness of the microcapsule A1 becomes thicker.

### Example 4

The same operation as in Example 3 was carried out except for the fact that, in the preparation of the coating fluid for forming the color developer layer, two kinds of microcapsule A-containing liquids (specifically, a microcapsule A1-containing liquid and a microcapsule A2-containing liquid) were used.

The results are shown in Table 1.

The amount of the microcapsule A2-containing liquid added was set to an amount at which the mass ratio of a microcapsule A1 to a microcapsule A2 in the color developer layer (hereinafter, regarded as “A1/A2 μmass ratio”) reached a value shown in Table 1.

The total amount of the amount of the microcapsule A1-containing liquid added and the amount of the microcapsule A2-containing liquid added in Example 4 was set to be the same as the amount of the microcapsule A1-containing liquid added in Example 1.

The microcapsule A1-containing liquid and the microcapsule A2-containing liquid in Example 4 were both prepared using the same method as for the microcapsule A1-containing liquid in Example 1. Here, regarding the microcapsule A2-containing liquid, the manufacturing condition was adjusted so that the D50A and wall thickness of the microcapsule A2 being contained reached values shown in Table 1. A method for changing D50A and the wall thickness is as described in Examples 2 and 3.

### Example 5

The same operation as in Example 4 was carried out except for the fact that, in the preparation of the first material in Example 4, an undercoat layer (hereinafter, also referred to as “UC layer”) was formed on a PET sheet as the first base material before the formation of the color developer layer.

The results are shown in Table 1.

The layer structure of the first material in Example 5 is a structure in which the UC layer and the color developer layer were disposed on the first base material in this order.

The UC layer was formed by applying a coating fluid for forming the undercoat layer prepared as described below onto a PET sheet as the first base material so that the film thickness after drying reached 4 μm and drying the coating fluid.

Preparation of Coating Fluid for Forming Undercoat Layer

Sodium=bis(3,3,4,4,5,5,6,6-nonafluoro)=2-sulfoniteoxysuccinate (manufactured by Fujifilm Corporation, solid content: 2% by mass, methanol solution) (13.3 parts) as a surfactant, 2-butoxyethanol (100 parts) as a film formation aid, and water (196 parts) were mixed into an acrylic resin water dispersion (JURYMER ET-410, manufactured by Toagosei Co., Ltd., solid content: 30% by mass) (691 parts) as a binder resin, thereby obtaining a coating fluid for the undercoat layer.

### Examples 6 and 7

The same operation as in Example 2 was carried out except for the fact that Ra of the surface of the developer layer was changed as shown in Table 1.

The results are shown in Table 1.

Ra of the surface of the developer layer was changed by changing the dispersion condition using the homogenizer (stirring rotation rate per unit time) in the preparation of the coating fluid for forming the developer layer.

Specifically, Ra of the surface of the developer layer increases as the stirring rotation rate per unit time becomes slower.

### Examples 8 and 9

The same operation as in Example 2 was carried out except for the fact that the CV value of the particle size distribution of the color developer layer was changed as shown in Table 1.

The results are shown in Table 1.

The CV value of the particle size distribution of the color developer layer was changed by changing the stirring time during the emulsification and dispersion.

Specifically, the CV value of the particle size distribution of the color developer layer increases as the stirring time becomes shorter.

### Example 10

The same operation as in Example 2 was carried out except for the fact that, in the preparation of the coating fluid for forming the color developer layer, furthermore, the following microcapsule B1-containing liquid containing the microcapsule B1 as the microcapsule B not encapsulating an electron-donating dye precursor was added thereto.

The results are shown in Table 1.

The amount of the microcapsule B1-containing liquid added was set to an amount at which the mass ratio of the microcapsule B1 to the microcapsule A1 in the color developer layer reached 20/100.

Preparation of Microcapsule B1-Containing Liquid

Synthetic isoparaffin (Idemitsu Kosan Co., Ltd., IP SOLVENT 1620) (15 parts) and N,N,N′,N′-tetrakis(2-hydroxypropyl)ethylene diamine (ADEKA Corporation, ADEKA POLYETHER EDP-300) dissolved in ethyl acetate (3 parts) (0.4 parts) were added to 1-phenyl-1-xylyl ethane (manufactured by Nippon Oil Corporation, HISOL SAS296) (78 parts), thereby obtaining a solution X.

The obtained solution X was stirred, and a trimethylolpropane adduct of torylene diisocyanate (DIC Corporation, BURNOCK D-750) dissolved in ethyl acetate (7 parts) (3 parts) was added thereto, thereby obtaining a solution Y.

Next, the solution Y was added to a solution obtained by dissolving polyvinyl alcohol (PVA-205, Kuraray Co., Ltd.) (9 parts) in water (140 parts), emulsified, and dispersed. Water (340 parts) was added to the obtained emulsified liquid, heated up to 70° C. under stirring, stirred for one hour, and then cooled. Water was further added to the cooled liquid, thereby adjusting the solid content concentration.

A microcapsule B1-containing liquid containing a microcapsule B1 as the microcapsule B not encapsulating an electron-donating dye precursor (solid content concentration: 19.6%) was obtained in the above-described manner.

For the microcapsule B1 that was contained in the microcapsule B1-containing liquid, the volume-based median size (hereinafter, also referred to as “D50B”) and the wall thickness were values shown in Table 1.

Methods for measuring the D50B and wall thickness of the microcapsule B1 were respectively set to be the same as the methods for measuring the D50A and wall thickness of the microcapsule A1.

In addition, a wall material of the microcapsule B1 was, as shown in Table 1, PUR (that is, a urethane-urea resin).

### Example 11

The same operation as in Example 4 was carried out except for the fact that, in the preparation of the coating fluid for forming the color developer layer, furthermore, the microcapsule B1-containing liquid was added thereto.

The results are shown in Table 1.

The amount of the microcapsule B1-containing liquid added was set to an amount at which the mass ratio of the microcapsule B1 to the total of the microcapsule A1 and the microcapsule A2 in the color developer layer (hereinafter, also referred to as “B1/(A1+A2) mass ratio”) reached a value shown in Table 1.

### Examples 12 and 13

The same operation as in Example 11 was carried out except for the fact that Ra of the surface of the developer layer was changed as shown in Table 1.

The results are shown in Table 1.

A method for changing Ra of the surface of the developer layer is the same as the method in Examples 6 and 7.

### Example 14

The same operation as in Example 2 was carried out except for the fact that the microcapsule A1-containing liquid in Example 1 was changed to the following microcapsule A1-containing liquid.

The results are shown in Table 1.

<Preparation of Microcapsule A1-Containing Liquid of Example 14>

A partial sodium salt of polyvinyl sulfonic acid (average molecular weight: 500,000) (10 parts) was added to and dissolved in hot water (80° C., 140 parts) under stirring, and then cooled, thereby obtaining an aqueous solution M1. The pH of this aqueous solution M1 was two to three. A 20% by mass sodium hydroxide aqueous solution was added to the aqueous solution M1, and the pH was adjusted to 4.0, thereby obtaining an aqueous solution M2.

Separately, a solution B2 (that is, a solution including the compound (A) that is an electron-donating dye precursor) was prepared in the same manner as the solution B in the preparation of the microcapsule A1-containing liquid in Example 1. Here, the amount of the solution B2 prepared was also set to be the same as the amount of the solution B prepared in Example 1.

The solution B2 was added to the aqueous solution M2, emulsified, and dispersed, thereby obtaining an emulsified liquid M3.

Separately, melamine (6 parts) and a 37% by mass formaldehyde aqueous solution (11 parts) were heated to 60° C. and stirred at this temperature for 30 μminutes, thereby obtaining a mixed aqueous solution M4 (pH 6 to 8) including melamine, formaldehyde, and a melamine-formaldehyde initial condensate.

Next, the emulsified liquid M3 and the mixed aqueous solution M4 were mixed together, the pH of a liquid was adjusted to 6.0 using a 3.6% by mass hydrochloric acid solution while stirring the obtained liquid, subsequently, the liquid temperature was increased to 65° C., and the liquid was continuously stirred at this temperature for 360 μminutes. The stirred liquid was cooled, and then the pH of the liquid was adjusted to 9.0 using a sodium hydroxide aqueous solution.

A microcapsule A1-containing liquid of Example 14 which contained a microcapsule A1 as the microcapsule A encapsulating an electron-donating dye precursor (pH: 9.0, solid content concentration: 19.6%) was obtained in the above-described manner.

For the microcapsule A1 that was contained in the microcapsule A1-containing liquid of Example 14, D50A and the wall thickness were values shown in Table 1.

Methods for measuring the D50A and wall thickness of the microcapsule A1 were as described above.

In addition, a wall material of the microcapsule A1 of Example 14 was, as shown in Table 1, a melamine formaldehyde resin (hereinafter, also referred as “MF”).

### Example 15

The same operation as in Example 14 was carried out except for the fact that, in the production of the first material in Example 14, a UC layer was formed on a PET sheet as the first base material before the formation of the color developer layer.

The results are shown in Table 1.

The UC layer was formed using the same method as that of the UC layer in Example 5.

### Example 16

The same operation as in Example 14 was carried out except for the fact that, in the preparation of the coating fluid for forming the color developer layer, two kinds of microcapsule A-containing liquids (specifically, a microcapsule A1-containing liquid and a microcapsule A2-containing liquid) were used.

The results are shown in Table 1.

The amount of the microcapsule A2-containing liquid in Example 16 added was set to an amount at which the A1/A2 μmass ratio in the color developer layer reached a value shown in Table 1.

The total amount of the amount of the microcapsule A1-containing liquid added and the amount of the microcapsule A2-containing liquid added in Example 16 was set to be the same as the amount of the microcapsule A1-containing liquid added in Example 14.

The microcapsule A1-containing liquid and the microcapsule A2-containing liquid in Example 16 were both prepared using the same method as for the microcapsule A1-containing liquid in Example 14. Here, the manufacturing condition was adjusted so that the D50A and wall thickness of the microcapsule A1 being contained in the microcapsule A1-containing liquid reached values shown in Table 1, and the manufacturing condition was adjusted so that the D50A and wall thickness of the microcapsule A2 being contained in the microcapsule A2-containing liquid reached values shown in Table 1.

A method for changing D50A and the wall thickness is as described in Examples 2 and 3.

### Example 17

The same operation as in Example 16 was carried out except for the fact that, in the preparation of the coating fluid for forming the color developer layer, furthermore, the following “microcapsule B1-containing liquid in Example 17” which contained a microcapsule B1 as the microcapsule B not encapsulating an electron-donating dye precursor was added thereto.

The results are shown in Table 1.

The amount of the microcapsule B1-containing liquid in Example 17 added was set to an amount at which the B1/(A1+A2) mass ratio in the color developer layer reached a value shown in Table 1.

<Preparation of Microcapsule B1-Containing Liquid in Example 17>

The microcapsule B1-containing liquid in Example 17 which contained a microcapsule B1 as the microcapsule B not encapsulating an electron-donating dye precursor was prepared in the same manner as in the preparation of the microcapsule A1-containing liquid in Example 14 except for the fact that the solution B2 (that is, a solution including the compound (A) that is an electron-donating dye precursor) was changed to a solution X2 (that is, a solution not including an electron-donating dye precursor) which is the same solution as the solution X in Example 10. Here, the amount of the solution X2 used was set to be the same as the amount of the solution X prepared in Example 10.

For the microcapsule B1 that was contained in the microcapsule B1-containing liquid of Example 17, D50B and the wall thickness were values shown in Table 1.

Methods for measuring the D50B and wall thickness of the microcapsule B1 were respectively set to be the same as the methods for measuring the D50A and wall thickness of the microcapsule A1.

In addition, a wall material of the microcapsule B1 was, as shown in Table 1, a melamine formaldehyde resin (hereinafter, also referred as “MF”).

### Examples 18 and 19

The same operation as in Examples 2 and 17 was carried out except for the fact that the activated clay as the clay substance (electron-accepting compound) was changed to kaolin (in detail, KAOBRITE manufactured by Shiraishi Calcium Kaisha, Ltd.) as the clay substance (electron-accepting compound).

The results are shown in Table 1.

The amount of kaolin used herein was set to be the same as the amount of the clay substance used in Example 2 (100 parts).

### Comparative Examples 1 and 2

The same operation as in Examples 2 and 10 was carried out except for the fact that, in Examples 2 and 10, the second material including the clay substance (activated clay) that is an electron-accepting compound was changed to the following comparative second material including a comparative substance that is an electron-accepting compound (specifically, 3,5-di-α-zinc methylbenzylsalicylate; hereinafter, also simply referred as “zinc salicylate”).

The results are shown in Table 1.

<Production of Comparative Second Material>

3,5-Di-α-zinc methylbenzylsalicylate (hereinafter, also simply referred to as “zinc salicylate”) that is a comparative substance (10 parts), calcium carbonate (100 parts), sodium hexametaphosphate (1 part), and water (200 parts) were dispersed using a sand grinder, thereby preparing a dispersion liquid. Next, a polyvinyl alcohol (PVA-203, Kuraray Co., Ltd.) 10% aqueous solution (100 parts), styrene-butadiene latex (10 parts in terms of the solid content), and water (450 parts) were added to the prepared dispersion liquid, thereby obtaining a coating fluid for forming a developer layer containing the comparative substance.

The coating fluid for forming a developer layer was applied onto a 75 μm-thick polyethylene terephthalate (PET) sheet (second base material) so that the dried film thickness reached 12 μm and dried, thereby forming a developer layer.

A comparative second material having the developer layer containing the comparative substance (zinc salicylate) disposed on the second base material was obtained in the above-described manner.

### Comparative Examples 3 and 4

The same operation as in Examples 2 and 10 was carried out except for the fact that, in Examples 2 and 10, Ra of the surface of the developer layer was changed as shown in Table 1.

The results are shown in Table 1.

A method for changing Ra of the surface of the developer layer is the same as the method in Examples 6 and 7.

### Comparative Example 5

The same operation as in Comparative Example 1 was carried out except for the fact that Ra of the surface of the developer layer was changed as shown in Table 1.

The results are shown in Table 1.

Ra of the surface of the developer layer was changed by changing the dispersion condition using the sand grinder (stirring rotation rate per unit time) in the production of the comparative second material in Comparative Example 1. Specifically, Ra of the surface of the developer layer increases as the stirring rotation rate per unit time becomes slower.

### Comparative Example 6

The same operation as in Example 2 was carried out except for the fact that Ra of the surface of the developer layer was changed as shown in Table 1.

The results are shown in Table 1.

A method for changing Ra of the surface of the developer layer is the same as the method in Examples 6 and 7.

TABLE 1

| | First material | | | | | | | | | | | | |
|---|---|---|---|---|---|---|---|---|---|---|---|---|---|
| | Color developer layer | | | | | | | | | | | | |
| | Microcapsule A | | | | | | Microcapsule B | | | | | | |
| | A1 | | | A2 | | | B1 | | | | | | |
| | | Wall | | | Wall | | | Wall | | | | | |
| | | thick- | | | thick- | | | thick- | | | | CV value of | |
| | D50A | ness | Wall | D50A | ness | Wall | D50B | ness | Wall | A1/A2 | B1/(A1 + A2) | particle size | |
| | (μm) | (nm) | material | (μm) | (nm) | material | (μm) | (nm) | material | mass ratio | mass ratio | distribution | UC layer |
| Example 1 | 20 | 47 | PUR | — | — | — | — | — | — | — | — | 65% | Absent |
| Example 2 | 25 | 58 | PUR | — | — | — | — | — | — | — | — | 65% | Absent |
| Example 3 | 30 | 70 | PUR | — | — | — | — | — | — | — | — | 65% | Absent |
| Example 4 | 30 | 70 | PUR | 15 | 35 | PUR | — | — | — | 60/40 | — | 70% | Absent |
| Example 5 | 30 | 70 | PUR | 15 | 35 | PUR | — | — | — | 60/40 | — | 70% | Present |
| Example 6 | 25 | 58 | PUR | — | — | — | — | — | — | — | — | 65% | Absent |
| Example 7 | 25 | 58 | PUR | — | — | — | — | — | — | — | — | 65% | Absent |
| Example 8 | 25 | 58 | PUR | — | — | — | — | — | — | — | — | 53% | Absent |
| Example 9 | 25 | 58 | PUR | — | — | — | — | — | — | — | — | 90% | Absent |
| Example 10 | 25 | 58 | PUR | — | — | — | 60 | 125 | PUR | — | 20/100 | 75% | Absent |
| Example 11 | 30 | 70 | PUR | 15 | 35 | PUR | 60 | 125 | PUR | 60/40 | 20/100 | 75% | Absent |
| Example 12 | 30 | 70 | PUR | 15 | 35 | PUR | 60 | 125 | PUR | 60/40 | 20/100 | 75% | Absent |
| Example 13 | 30 | 70 | PUR | 15 | 35 | PUR | 60 | 125 | PUR | 60/40 | 20/100 | 75% | Absent |
| Example 14 | 25 | 58 | MF | — | — | — | — | — | — | — | — | 65% | Absent |
| Example 15 | 25 | 58 | MF | — | — | — | — | — | — | — | — | 65% | Present |
| Example 16 | 30 | 70 | MF | 15 | 35 | MF | — | — | — | 60/40 | — | 70% | Absent |
| Example 17 | 30 | 70 | MF | 15 | 35 | MF | 60 | 125 | MF | 60/40 | 20/100 | 75% | Absent |
| Example 18 | 25 | 58 | PUR | — | — | — | — | — | — | — | — | 65% | Absent |
| Example 19 | 30 | 70 | MF | 15 | 35 | MF | 60 | 125 | MF | 60/40 | 20/100 | 75% | Absent |
| Comparative | 25 | 58 | PUR | — | — | — | — | — | — | — | — | 65% | Absent |
| Example 1 | | | | | | | | | | | | | |
| Comparative | 25 | 58 | PUR | — | — | — | 60 | 125 | PUR | — | 20/100 | 75% | Absent |
| Example 2 | | | | | | | | | | | | | |
| Comparative | 25 | 58 | PUR | — | — | — | — | — | — | — | — | 65% | Absent |
| Example 3 | | | | | | | | | | | | | |
| Comparative | 25 | 58 | PUR | — | — | — | 60 | 125 | PUR | — | 20/100 | 75% | Absent |
| Example 4 | | | | | | | | | | | | | |
| Comparative | 25 | 58 | PUR | — | — | — | — | — | — | — | — | 65% | Absent |
| Example 5 | | | | | | | | | | | | | |
| Comparative | 25 | 58 | PUR | — | — | — | — | — | — | — | — | 65% | Absent |
| Example 6 | | | | | | | | | | | | | |

| | | | Evaluation | | | | | | | |
|---|---|---|---|---|---|---|---|---|---|---|
| | Second material | | | | Visibility of | | | | | Color optical |
| | Developer layer | | | | shape of | | Gradation | | | density after |
| | Clay substance | | | Blue of color | color | Color | property of | Color | | storage |
| | or comparative | Ra | | development | development | development | color | development | | (absolute |
| | substance | (μm) | Δ D | region | region | by rubbing | development | rate | | value) |
| Example 1 | Activated clay | 1.4 | 0.18 | 5 | 5 | 4 | 4 | 30 | seconds | 80% |
| Example 2 | Activated clay | 1.4 | 0.18 | 5 | 5 | 4 | 4 | 30 | seconds | 80% |
| Example 3 | Activated clay | 1.4 | 0.18 | 5 | 5 | 4 | 4 | 30 | seconds | 80% |
| Example 4 | Activated clay | 1.4 | 0.18 | 5 | 5 | 4 | 5 | 30 | seconds | 80% |
| Example 5 | Activated clay | 1.4 | 0.18 | 5 | 5 | 4 | 5 | 30 | seconds | 80% |
| Example 6 | Activated clay | 1.8 | 0.21 | 5 | 4 | 3 | 4 | 30 | seconds | 80% |
| Example 7 | Activated clay | 2.7 | 0.24 | 5 | 3 | 3 | 4 | 30 | seconds | 80% |
| Example 8 | Activated clay | 1.4 | 0.21 | 5 | 5 | 4 | 3 | 30 | seconds | 80% |
| Example 9 | Activated clay | 1.4 | 0.15 | 5 | 5 | 3 | 3 | 30 | seconds | 80% |
| Example 10 | Activated clay | 1.4 | 0.20 | 5 | 5 | 5 | 4 | 30 | seconds | 80% |
| Example 11 | Activated clay | 1.4 | 0.20 | 5 | 5 | 5 | 5 | 30 | seconds | 80% |
| Example 12 | Activated clay | 1.8 | 0.22 | 5 | 5 | 5 | 5 | 30 | seconds | 80% |
| Example 13 | Activated clay | 2.7 | 0.25 | 5 | 3 | 4 | 5 | 30 | seconds | 80% |
| Example 14 | Activated clay | 1.4 | 0.18 | 5 | 5 | 4 | 4 | 30 | seconds | 90% |
| Example 15 | Activated clay | 1.4 | 0.18 | 5 | 5 | 4 | 4 | 30 | seconds | 90% |
| Example 16 | Activated clay | 1.4 | 0.18 | 5 | 5 | 4 | 5 | 30 | seconds | 90% |
| Example 17 | Activated clay | 1.4 | 0.20 | 5 | 5 | 5 | 5 | 30 | seconds | 90% |
| Example 18 | Kaolin | 1.4 | 0.18 | 5 | 5 | 4 | 4 | 30 | seconds | 80% |
| Example 19 | Kaolin | 1.4 | 0.20 | 5 | 5 | 5 | 5 | 30 | seconds | 90% |
| Comparative | Zinc salicylate | 1.0 | 0.10 | 2 | 5 | 5 | 2 | 2 | minutes | 80% |
| Example 1 | | | | | | | | | | |
| Comparative | Zinc salicylate | 1.0 | 0.12 | 2 | 5 | 5 | 3 | 2 | minutes | 80% |
| Example 2 | | | | | | | | | | |
| Comparative | Activated clay | 1.0 | 0.10 | 5 | 5 | 5 | 2 | 30 | seconds | 80% |
| Example 3 | | | | | | | | | | |
| Comparative | Activated clay | 1.0 | 0.12 | 5 | 5 | 5 | 3 | 30 | seconds | 80% |
| Example 4 | | | | | | | | | | |
| Comparative | Zinc salicylate | 1.4 | 0.18 | 1 | 5 | 4 | 4 | 2 | minutes | 80% |
| Example 5 | | | | | | | | | | |
| Comparative | Activated clay | 3.3 | 0.26 | 5 | 2 | 2 | 4 | 30 | seconds | 80% |
| Example 6 | | | | | | | | | | |

As shown in Table 1, in Examples 1 to 19 for which the material for pressure measurement including the first material having the color developer layer containing the microcapsule A encapsulating an electron-donating dye precursor disposed on the first base material and the second material having the developer layer containing the clay substance that is an electron-accepting compound disposed on the second base material, in which Ra of the surface of the developer layer satisfied 1.1 μm<Ra≤3.0 μm, was used, the color optical density difference ΔD before and after pressurization at 0.03 MPa was large, the bleeding of the color development region was suppressed, and the visibility of the shape of the color development region was excellent.

In Examples 1 to 19 and Comparative Examples 1 to 6, Ra's of the surfaces of the color developer layers were measured in the same manner as Ra's of the surfaces of the developer layers. As a result, in all of the examples, Ra's of the surfaces of the color developer layers satisfied 1.5 μm<Ra≤2.8 μm.

In Comparative Examples 1, 2, and 5 in which, in contrast to Examples 1 to 19, the comparative substance (zinc salicylate) was used instead of the clay substance that is an electron-accepting compound, the bleeding of the color development region occurred.

In addition, in Comparative Examples 1 to 4 in which Ra of the surface of the developer layer was 1.1 μm or less, ΔD became small.

In addition, in Comparative Example 6 in which Ra of the surface of the developer layer was more than 3.0 μm, the visibility of the shape of the color development region was poor.

In addition, from the comparison between Example 8 and other examples, it is found that, in a case where the CV value of the particle size distribution of the color developer layer (that is, the coefficient of variation of the number-based particle size distribution of particles having a particle diameter of 2 μm or more contained in the color developer layer) is 60% or more, the gradation property of color development further improves.

In addition, from the comparison between Example 9 and other examples, it is found that, in a case where the CV value of the particle size distribution of the color developer layer is 80% or less, color development by rubbing is suppressed, and the gradation property of color development further improves.

In addition, from the comparison between Examples 10 to 13 and Examples 1 to 9, it is found that, in a case where the color developer layer contains the microcapsule B not encapsulating an electron-donating dye precursor, color development by rubbing is further suppressed.

In addition, from the comparison between Examples 14 to 17, 19 and other examples, it is found that, in a case where the wall materials of the microcapsule A and/or the microcapsule B (that is, the material of the capsule wall) is MF (that is, a melamine formaldehyde resin), the color optical density after storage is maintained on a high level.

The disclosure of Japanese Patent Application No. 2017-108376 filed on May 31, 2017 is all incorporated into the present specification by reference.

All of documents, patent applications, and technical standards described in the present specification are incorporated into the present specification by reference to approximately the same extent as a case where it is specifically and respectively described that the respective documents, patent applications, and technical standards are incorporated by reference.

What is claimed is:

1. A material for pressure measurement comprising:
a first material having a color developer layer containing a microcapsule A encapsulating an electron-donating dye precursor disposed on a first base material; and
a second material having a developer layer containing a clay substance that is an electron-accepting compound disposed on a second base material,
wherein an arithmetic average roughness Ra of a surface of the developer layer satisfies 1.1 μm<Ra≤3.0 μm.

2. The material for pressure measurement according to claim 1,
wherein an arithmetic average roughness Ra of a surface of the color developer layer satisfies 1.1 μm<Ra≤3.0 μm.

3. The material for pressure measurement according to claim 1,
wherein a coefficient of variation of a number-based particle size distribution of particles having a particle diameter of 2 μm or larger contained in the color developer layer is 50% to 100%.

4. The material for pressure measurement according to claim 3,
wherein an arithmetic average roughness Ra of a surface of the color developer layer satisfies 1.1 μm≤Ra≤3.0 μm.

5. The material for pressure measurement according to claim 1,
wherein at least one of the color developer layer or the developer layer contains a microcapsule B not encapsulating the electron-donating dye precursor.

6. The material for pressure measurement according to claim 1,
wherein the color developer layer contains a microcapsule B not encapsulating the electron-donating dye precursor.

7. The material for pressure measurement according to claim 4,
wherein the color developer layer contains a microcapsule B not encapsulating the electron-donating dye precursor.

8. The material for pressure measurement according to claim 5,
wherein a material of a capsule wall of the microcapsule B is a melamine formaldehyde resin.

9. The material for pressure measurement according to claim 1,
wherein a material of a capsule wall of the microcapsule A is a melamine formaldehyde resin.

10. The material for pressure measurement according to claim 7,
wherein a material of a capsule wall of each of the microcapsule A and the microcapsule B is a melamine formaldehyde resin.

11. The material for pressure measurement according to claim 1,
wherein the clay substance is at least one selected from the group consisting of acid clay, activated clay, attapulgite, zeolite, bentonite and kaolin.

12. The material for pressure measurement according to claim 7,
wherein the clay substance is at least one selected from the group consisting of acid clay, activated clay, attapulgite, zeolite, bentonite and kaolin.

13. The material for pressure measurement according to claim 10,
wherein the clay substance is at least one selected from the group consisting of acid clay, activated clay, attapulgite, zeolite, bentonite and kaolin.

14. The material for pressure measurement according to claim 1,
wherein a color optical density difference ΔD before and after pressurization at 0.03 MPa is 0.15 or more.

15. The material for pressure measurement according to claim 12,
wherein a color optical density difference ΔD before and after pressurization at 0.03 MPa is 0.15 or more.

16. The material for pressure measurement according to claim 13,
wherein a color optical density difference ΔD before and after pressurization at 0.03 MPa is 0.15 or more.

17. The material for pressure measurement according to claim 1,
wherein the arithmetic average roughness Ra of the surface of the developer layer satisfies 1.1 μm<Ra<1.6 μm.

18. The material for pressure measurement according to claim 1,
wherein an arithmetic average roughness Ra of a surface of the color developer layer satisfies 1.5 μm<Ra≤2.8 μm.

19. The material for pressure measurement according to claim 16,
wherein the arithmetic average roughness Ra of the surface of the developer layer satisfies 1.1 μm<Ra<1.6 μm, and an arithmetic average roughness Ra of a surface of the color developer layer satisfies 1.5 μm<Ra≤2.8 μm.
